(19) United States
(12) Patent Application Publication
(10) Pub. No.: US 2017/0009000 A1
(43) Pub. Date: Jan. 12, 2017

(54) FLUOROPOLYMER STRUCTURES

(71) Applicants: DAIKIN AMERICA INC., Orangeburg, NY (US); DAIKIN INDUSTRIES, LTD., Osaka-shi, Osaka (JP)

(72) Inventors: Ronald E. HENDERSHOT, Decatur, AL (US); Kenneth E. MILAM, Decatur, AL (US); Katsuhiko IMOTO, Settsu, Osaka (JP)

(73) Assignees: DAIKIN AMERICA INC., Orangeburg, NY (US); DAIKIN INDUSTRIES, LTD., Osaka-shi (JP)

(21) Appl. No.: 15/116,402

(22) PCT Filed: Feb. 26, 2015
(86) PCT No.: PCT/JP2015/056441

§ 371 Date: Aug. 3, 2016

Related U.S. Application Data
(63) Continuation of application No. 14/191,028, filed on Feb. 26, 2014, now abandoned.

(51) Int. Cl. C08G 18/62; B32B 15/08; B32B 5/18; B32B 3/12; C08J 5/18; B64C 1/06

(52) U.S. Cl. CPC C08G 18/6279; C08J 5/18; B64C 1/066; B32B 5/18; B32B 3/12; B32B 15/08; C08J 2327/12; B32B 2605/18; B32B 2605/003; B32B 2307/3065; B32B 2255/06; B32B 2255/26

(57) ABSTRACT

Fluoropolymer structures are provided for use in aircraft interiors. The structures include an external cross-linked fluoropolymer layer that is lighter and safer than conventional fluoropolymer film layers. In general these structures can be described as a panel for the interior of an aerospace vehicle made of an aluminum or fiber composite facesheet, a foam or honeycomb core attached to the facesheet, and a layer of cross-linked fluoropolymer on the surface of the facesheet that is on the side facing away from the core. Methods of making and using the structures are also provided.

### TECHNICAL FIELD

The present disclosure relates generally to fluoropolymer structures. Such structures as well as methods of making and using them are provided.

### BACKGROUND ART

Aircraft materials must meet very demanding performance requirements. They must confer high levels of mechanical strength, high levels of dimensional stability, and low heat release upon combustion. Although the greatest demands are placed on airframe parts, interior structures of an aircraft must also meet stringent requirements. In addition to having adequate mechanical strength and low heat release characteristics, the interior structures of an aircraft must protect passengers and crew from harm in the event of a fire. To do so, such interior structures must be fire resistant; if they do burn they must release minimal amounts of smoke and airborne toxins. In addition, like all aircraft structures, the interior structures of the aircraft must be as light as possible to conserve fuel. This combination of characteristics is challenging to achieve.

Such interior aircraft structures include floor panels, ceiling panels, cargo liners, overhead stowage bins, window surrounds, laboratory modules, galleys, food and drink trolleys, ventilation ducts, and bulkheads.

The interior structures of aircraft are conventionally made of advanced composite materials. In many cases such composite structures are made of “sandwich panels.” A sandwich panel is a lightweight foam or honeycomb core sandwiched between two facesheets (in some cases there may be only one facesheet). The core provides increased stiffness to the facesheets, which are roughly proportional to the thickness of the core. The facesheets are generally coated with a thin layer of decorative film or laminate, such as a polymeric film on their exterior surfaces. Such films and laminates can advantageously render the sandwich panel impermeable to air, improve its scratch resistance, improve its stain resistance, and provide for easy cleaning.

In modern aircraft, the lightweight core is usually made of a composite honeycomb core of the meta-aramid compound NOMEX™ (DuPont Advanced Fiber Systems, Richmond, Va.) and a phenolic resin. Some structures, such as partitions and floor panels, sometimes use a core made of aluminum honeycomb. The facesheet is typically made of a two or three ply composite of glass or carbon fibers in phenolic or epoxy resin; sometimes the facesheet is made of aluminum.

### SUMMARY OF INVENTION

### Technical Problem

Currently the most popular film or laminate placed on the exterior surfaces of the facesheets is the polyvinyl fluoride compound TEDLAR™ (available from DuPont Engineering Polymers, Wilmington, Del.), with a monomer structure of —CH₂CFH—. Although TEDLAR displays adequate performance in terms of flame resistance, it is generally applied in relatively thick layers greater than 2 mils (50.8 μm), which adds to the weight and cost of the panel (and, consequently, of the aircraft). It also is only available in limited forms, including only 3 colors and few if any variations in thickness. TEDLAR films have additional problems with processability including being unable to easily conform to curved surfaces which are common in aircraft manufacturing. TEDLAR polymer alone also produces toxic hydrogen fluoride (HF) gas upon combustion, necessitating the addition of additives to absorb the hydrogen fluoride. TEDLAR is applied as a film and requires some type of adhesive to ensure it remains in position.

Consequently there is a need in the art for sandwich panels that replace TEDLAR.

### Solution to Problem

The problems identified in the previous section, as well as others, have been addressed by the use of structures of cross-linked fluoropolymers provided in this disclosure (although it is to be understood that not every embodiment of such use will address every such problem in the art).

One such structure is a panel for the interior of an aerospace vehicle, the panel comprising: an aluminum or fiber composite facesheet; a foam or honeycomb core attached to the facesheet; and a layer of cross-linked fluoropolymer on the surface of the facesheet that is on the side facing away from the core.

Another such structure is a cross-linked fluoropolymer film. A method of making a cross-linked fluoropolymer film is provided, comprising: applying a layer of cross-linkable fluoropolymer to a fluoropolymer substrate; curing the layer of cross-linkable fluoropolymer by cross-linking the fluoropolymer to create a cured fluoropolymer film; and removing the cured fluoropolymer film from the substrate.

A method of making a panel for the interior of an aerospace vehicle is provided. In a general embodiment, the method comprises: providing a structure comprising an aluminum or fiber composite facesheet and a foam or honeycomb core attached to the facesheet; applying a layer of cross-linkable fluoropolymer on the surface of the facesheet that is on the side facing away from the core; and curing the layer of cross-linkable fluoropolymer by allowing the fluoropolymer to cross-link. An alternate general embodiment of the method comprises: providing a structure comprising an aluminum or fiber composite facesheet and a foam or honeycomb core attached to the facesheet; and applying a film of cross-linked fluoropolymer on the surface of the facesheet that is on the side facing away from the core.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

FIG. 1: This FIGURE shows an embodiment of the panel in cross-section (not to scale).

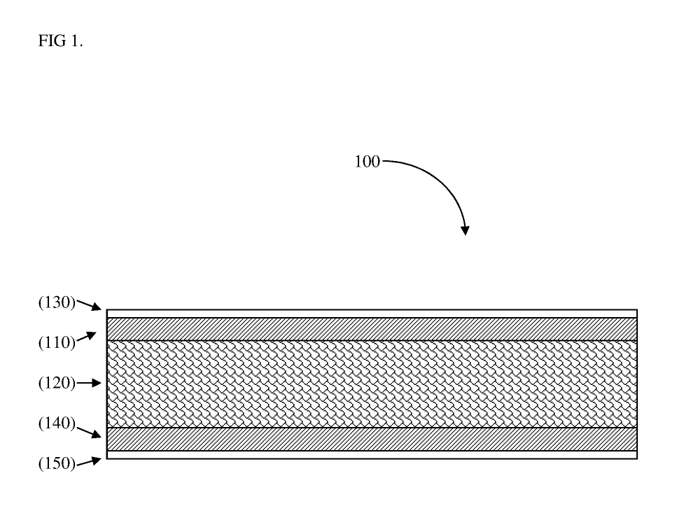

### DESCRIPTION OF EMBODIMENTS

### A. Definitions

The terms “about” and “approximately” shall generally mean an acceptable degree of error or variation for the quantity measured given the nature or precision of the measurements. Typical, exemplary degrees of error or variation are within 20%, preferably within 10%, and more preferably within 5% of a given value or range of values.

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “consisting essentially of” means that, in addition to the recited elements, what is claimed or described may also contain other elements (steps, structures, ingredients, components, etc.) that do not adversely affect the operability of what is claimed or described for its intended purpose. Such addition of other elements that do not adversely affect the operability of what is claimed or described for its intended purpose would not constitute a material change in the basic and novel characteristics of what is claimed or described.

### B. Aerospace Panel

A panel 100 for the interior of an aerospace vehicle is provided, the panel 100 comprising: an aluminum or fiber composite facesheet 110; a foam or honeycomb core 120 attached to the facesheet 110; and a layer of cross-linked fluoropolymer 130 on the surface of the facesheet 110 that is on the side facing away from the core 120.

The core 120 and facesheet 110 may be any that are known in the art to be suitable for aircraft interiors. In some embodiments the core 120 is composed of a NOMEX and phenolic composite or aluminum. In more specific embodiments the core 120 is a honeycomb of a NOMEX and phenolic composite or aluminum. If the facesheet 110 is a fiber composite, the fiber may be, in some embodiments, fiberglass or carbon fiber. The fiber composite may have a resin component, such as a phenolic resin or an epoxy resin. In a specific embodiment the resin component is epoxy or epoxy tape or fabric. The facesheet 110 may have multiple layers or a single layer, and so may be described in various embodiments as a 1-ply facesheet, a 2-ply facesheet, or a 3-ply facesheet.

Some embodiments of the panel 100 comprise a second facesheet 140 attached to the core 120 on the surface of the core 120 facing away from the first facesheet 110, and a second layer of cross-linked fluoropolymer 150 on the surface of the second facesheet 140 that is on the side facing away from the core 120. The second layer of cross-linked polymer 150 may be made from the same type of cross-linked fluoropolymer as the first layer 130, or it may be another cross-linked fluoropolymer. Similarly, the second facesheet 140 may be similar or identical to the first facesheet 110, but this will not be true in every embodiment.

The cross-linked fluoropolymer is composed of one or more cross-linkable fluoropolymers that are cross-linked (covalently bound) to one another. The cross-linked fluoropolymer is in some embodiments the product of curing the cross-linkable fluoropolymers by allowing them to cross-link. The cross-linkable fluoropolymers may be a fluorine-containing copolymer, such as a random copolymer or a sequential copolymer.

In some embodiments of the panel 100 the at least one of the cross-linkable fluoropolymers is a fluorinated polyol or fluoroethane copolymer. In further embodiments at least one of the cross-linkable fluoropolymers is a tetrafluoroethane copolymer.

The cross-linkable fluoropolymer comprises a plurality of monomers. In some embodiments of the cross-linkable fluoropolymer, at least one of the monomers is fluorine-containing monomer, such as a fluoroalkyl group. In further embodiments of the cross-linkable fluoropolymer, at least one of the monomers is a fluoroalkyl group and at least one of the monomers is a substituted alkyl or aryl group comprising a cross-linkable moiety. The fluoroalkyl group may be any fluoroalkyl group, and in a specific example is a fluoroethyl group. Such fluoroethyl groups include monofluoroethyl, difluoroethyl, trifluoroethyl, or tetrafluoroethyl. In further embodiments of the cross-linkable fluoropolymer, the fluoroalkyl group is CF₂═CFX, in which X is a halogen or hydrogen. In still further embodiments X is fluorine or chlorine. In a specific embodiment, X is fluorine. In another specific embodiment, X is chlorine.

In those embodiments of the cross-linkable fluoropolymer comprising a substituted alkyl group, the substituted alkyl group may be a substituted ethyl group. The substituted ethyl group may be, for example, a hydroxyl-substituted ethyl group. In a specific example, the substituted alkyl group is CH₂═CH—R—OH.

The cross-linkable moiety may be any known in the art, and in some embodiments is an alkoxy or aryloxy moiety. In specific examples, the cross-linkable moiety is a hydroxyl moiety, ester moiety, or an ether moiety.

Further embodiments of the cross-linkable fluoropolymer comprise an alkyl ether monomer.

Some embodiments of the cross-linkable fluoropolymer are copolymers of at least a fluorine-containing monomer and a hydroxyl monomer. Particular and non-limiting examples include, for example: fluoroolefin-based cross-linkable fluoropolymers which can be obtained by copolymerizing fluoroolefin, a hydroxyl-containing radically polymerizable unsaturated monomer, and, if necessary, other radically polymerizable unsaturated monomer being copolymerizable therewith; fluorine-containing acrylic cross-linkable fluoropolymers which can be obtained by copolymerizing a monomer which has a perfluoroalkyl group or a perfluoroalkenyl group at one end thereof and an ethylenic double bond at the other end, a hydroxyl-containing acrylate, and if, necessary, other radically polymerizable unsaturated monomer being copolymerizable therewith; and the similar compounds. Examples of fluoroolefins include one or more of tetrafluoroethylene (TFE), chlorotrifluoroethylene (CTFE), trifluoroethylene (TrFE), vinylidene fluoride (VdF) and hexafluoropropylene (HFP), and especially, TFE, CTFE and VdF are preferable in view of excellent solvent solubility of fluoroolefin-based cross-linkable fluoropolymers obtained therefrom and excellent weather resistance, heat resistance and chemical resistance of the obtained coating films. Examples of hydroxyl-containing radically polymerizable unsaturated monomers include those having hydroxyl groups and a radically polymerizable unsaturated double bond being radically copolymerizable with fluoroolefin. Examples include hydroxyalkyl vinyl ethers such as hydroxyethyl vinyl ether, hydroxypropyl vinyl ether, hydroxybutyl vinyl ether and hydroxypentyl vinyl ether; hydroxyallyl ethers such as ethylene glycol monoallyl ether, diethylene glycol monoallyl ether, triethylene glycol monoallyl ether and glycerin monoallyl ether; and furthermore, adducts of these hydroxyl-containing radically polymerizable unsaturated monomers and lactones such as ε-caprolactone and γ-valerolactone. Other copolymerizable radically polymerizable unsaturated monomers can be selectively used from well-known monomers depending on desired performances of coating films. Particularly, examples thereof include a-olefins such as ethylene, propylene, isobutylene, butylene-1 and chloroprene; vinyl ethers such as ethyl vinyl ether, isobutyl vinyl ether, butyl vinyl ether, cyclohexyl vinyl ether, propyl vinyl ether, isopropyl vinyl ether, tert-butyl vinyl ether, pentyl vinyl ether and hexyl vinyl ether; allyl vinyl ethers such as phenyl vinyl ether, o-, m-, p-trivinyl ether; carboxylic acid vinyl esters such as vinyl acetate, vinyl lactate, vinyl butyrate, vinyl isobutyrate, vinyl caproate, vinyl isocaproate, vinyl pivalate, vinyl versatate (e.g. CH₂═CHOC═OC₈H₁₇, CH₂═CHOC═OC₉H₁₉) and vinyl benzoate; isopropenyl esters of aliphatic acids such as isopropenyl acetate and isopropenyl propionate. The cross-linkable fluoropolymers may further include a carboxyl group. The carboxyl group can be introduced, for example, by addition reaction of a part of hydroxyl groups in the cross-linkable fluoropolymer and polybasic anhydrides (e.g. itaconic anhydride, succinic anhydride). When the cross-linkable fluoropolymer is a fluorine-containing acrylic compound, examples of the monomers having a perfluoroalkyl group or a perfluoroalkenyl group at one end and an ethylenic double bond at the other end include: perfluorobutyl ethyl methacrylate, perfluorooctylethyl methacrylate, perfluoroisononyl ethyl methacrylate, and perfluorodecyl ethyl methacrylate. Examples of hydroxyl-containing acrylate monomer include 2-hydroxyethyl acrylate, hydroxypropyl acrylate, 2-hydroxyethyl methacrylate, and hydroxypropyl methacrylate. Examples of other radically polymerizable unsaturated monomers being copolymerizable with the above-mentioned monomers in the cross-linkable fluoropolymer include: esters of alkyl (meth)acrylates, such as methyl acrylate, ethyl acrylate, propyl acrylate, isopropyl acrylate, butyl acrylate, hexyl acrylate, octyl acrylate, lauryl acrylate, cyclohexyl acrylate, methyl methacrylate, ethyl methacrylate, propyl methacrylate, isopropyl methacrylate, butyl methacrylate, hexyl methacrylate, octyl methacrylate and lauryl methacrylate; ethylenically unsaturated carboxylic acids, such as acrylic acid and methacrylic acid; aromatic vinyl monomers, such as styrene, a-methyl styrene and vinyltoluene; amide compounds of (meth)acrylate and derivatives thereof; and acrylonitriles such as acrylonitrile and methacrylonitrile.

The number average molecular weight of the cross-linkable fluoropolymer may be within a range from about 2,000-100,000. The number average molecular weight of some embodiments of the cross-linkable fluoropolymer is within a range from about 5,000-80,000; such embodiments have the advantages of retaining durability and staining resistance, compatibility with curing agents, compatibility with hydrophilizing agents, compatibility with hydrophilization accelerating catalysts, and good storage stability.

Some embodiments of the cross-linkable fluoropolymer have hydroxyl values of about 20-200 mg KOH/g. More specific embodiments of the cross-linkable fluoropolymer have hydroxyl values of about 50-150 mg KOH/g.

Examples of commercially available cross-linkable fluoropolymers for use in the panel 100 include LUMIFLON (Asahi Glass Co., Ltd., Tokyo, Japan), CEFRAL COAT (Central Glass Co., Ltd., Tokyo, Japan), ZEFFLE (Daikin Industries, Ltd., Osaka, Japan) and FLUONATE (DIC Corporation, Tokyo, Japan).

In a specific embodiment, the cross-linkable fluoropolymer is ZEFFLE-GK-570™ (available from DAIKIN AMERICA, INC. of Orangeburg, N.Y., USA). ZEFFLE-GK-570 is a cross-linkable random fluorine-containing copolymer, comprising (but not limited to) the following three monomers: CF₂═CF₂, CH₂═CH—R₅—OH, and CH₂═CH—OR₆. The hydroxyl moiety and R₅ in the hydroxyl-containing monomer is the cross-linking moiety, which is activated by various cross-linking agents, such as isocyanates. The ether-containing moiety and R₆ contributes to the polymer's gloss and compatibility with other agents. The fluorine-containing monomer contributes to the excellent weathering and durability of the polymer.

In another specific embodiment, the cross-linkable fluoropolymer is LUMIFLON (commercially available from ASAHI GLASS CO., of Japan). LUMIFLON™ is a cross-linkable fluoropolymer of five monomers, specifically: CF₂═CFX (X being a halogen), CH₂═CHOR₁, CH₂═CHOR₂, CH₂═CHOR₃, and CH₂═CHOR₄. The R groups have specific functions, those being that R₁ is a group that confers a property selected from the group consisting of transparency, gloss, and hardness; R₂ is a group that confers flexibility; R₃ is a cross-linking moiety; and R₄ is a group that confers a property selected from the group consisting of pigment compatibility and adhesiveness.

The layer of cross-linked fluoropolymer 130 will often be at least about 2 mils (50.8 μm) or less in thickness, as this is adequate to resist flame and reasonably lightweight. In various embodiments of the panel 100 the thickness of the layer of cross-linked fluoropolymer 130 will be at least about one of the following values: 0.25 mil (6.35 μm), 0.5 mil (12.7 μm), 0.75 mil (19.05 μm), 1.0 mil (25.4 μm), 1.25 mil (31.75 μm), 1.5 mil (38.1 μm), 1.75 mil (44.45 μm), 2.0 mil (50.8 μm), 2.25 mil (57.15 μm), and 2.5 mil (63.5 μm). In further embodiments the layer of cross-linked fluoropolymer 130 is about 0.5-2.5 mils thick (12.7-63.5 μm). In a specific embodiment the layer of cross-linked fluoropolymer 130 is about 1 mil (25.4 μm) thick. In a further specific embodiment the layer of cross-linked fluoropolymer 130 is about 0.59 (15 μm) thick.

Some embodiments of the cross-linked fluoropolymer meet certain performance standards relevant to use inside aircraft. Some embodiments of the cross-linked fluoropolymer meet the smoke emissions requirements specified in Boeing Document D6-51377, Revision F, paragraph 4.1b(1) & (3) and Table 2 for general plastic parts, when tested for smoke generation per Boeing Specification Support Standard 7238, “Test Method for Smoke Generation by Materials on Combustion” Revision C, dated 24 May 2006 (which are incorporated by reference in their entireties as needed to enable those of ordinary skill in the art to conduct such tests). Specifically, the optical density of smoke (⁴Dₘₐₓ) produced by the cross-linked fluoropolymer does not exceed about 200. In more specific embodiments, the ⁴Dₘₐₓ of the smoke produced by the cross-linked fluoropolymer is less than about 6. In more specific embodiments, the ⁴Dₘₐₓ of the smoke produced by the cross-linked fluoropolymer does not exceed about 4.

Some embodiments of the cross-linked fluoropolymer meet the toxic gas emission limits specified within D6-51377, Revision F, Paragraph 4.1b(1) & (3) and Table 1, when tested for toxicity in the flaming test mode per Boeing Specification Support Standard 7239, “Test Method for Toxic Gas Generation by Materials Combustion,” Revision A, dated 18 Jan. 1988 (which are incorporated by reference in their entireties as needed to enable those of ordinary skill in the art to conduct such tests). Specifically, the concentration of HCl generated does not exceed about 500 ppm, the concentration of NOₓ generated does not exceed about 100 ppm, the concentration of HCN generated does not exceed about 150 ppm, the concentration of SO₂ generated does not exceed about 100 ppm, and the concentration of HF generated does not exceed about 200 ppm. Specific embodiments of the cross-linked fluoropolymer emit one or more of the following toxic gases at the specified concentrations: CO below about 30 ppm, HCl below about 2 ppm, NOₓ below about 8 ppm, HCN below about 1 ppm, SO₂ at about 0 ppm, and HF at about 0 ppm. More specific embodiments of the cross-linked fluoropolymer emit one or more of the following toxic gases at the specified concentrations: CO does not exceed about 20 ppm, HCl does not exceed about 1 ppm, NOₓ does not exceed about 4 ppm, HCN does not exceed about 0.5 ppm, SO₂ at about 0 ppm, and HF at about 0 ppm. Further embodiments of the cross-linked fluoropolymer emit no detectable HF measured by the tests specified above, even in the absence of agents that absorb HF. Accordingly, some embodiments of the panel 100 do not contain an agent that absorbs HF at sufficient levels to absorb HF that would otherwise be emitted by the burning cross-linked fluoropolymer.

Some embodiments of the cross-linked fluoropolymer are flame resistant, and will be rated as V-0 or better when tested according to UL 94, “Standard for Safety of Flammability of Plastic Materials for Parts in Devices and Appliances Testing” (incorporated herein by reference to enable one of ordinary skill in the art to perform the test).

In a specific embodiment of the panel 100, the layer of cross-linked fluoropolymer 130 on the surface of the facesheet 110 is a film of any of the cross-linked fluoropolymers described above. If the layer of cross-linked fluoropolymer 130 is a film, then in many embodiments an adhesive will be used to secure the film to the facesheet 110. A specific embodiment of the film is a film of ZEFFLE-GK-570. Such films can be formed by applying a layer of cross-linkable fluoropolymer to a fluoropolymer substrate; curing the layer of cross-linkable fluoropolymer by cross-linking the fluoropolymer to create a cured fluoropolymer film; and removing the cured fluoropolymer film from the substrate. Although it was previously believed that formation of a mechanical film required a polymer with more mechanical strength than ZEFFLE-GK, it has been surprisingly discovered that ZEFFLE-GK readily forms strong films on fluoropolymer substrates. Fluoropolymer substrates are favored over certain other substrates, such as polypropylene (which can be damaged at the cure temperatures for ZEFFLE-GK) and polyethylene (to which the film has been observed to stick). In a specific embodiment, the ZEFFLE-GK film is about 28 μm in thickness.

### C. Methods of Making Aerospace Panels

A method of making a panel 100 for the interior of an aerospace vehicle is provided. In a general embodiment, the method comprises: providing a structure comprising an aluminum or fiber composite facesheet 110 and a foam or honeycomb core 120 attached to the facesheet 110; applying a layer of cross-linkable fluoropolymer on the surface of the facesheet 110 that is on the side facing away from the core 120; and curing the layer of cross-linkable fluoropolymer by allowing the fluoropolymer to cross-link. An alternate general embodiment of the method comprises: providing a structure comprising an aluminum or fiber composite facesheet 110 and a foam or honeycomb core 120 attached to the facesheet 110; and applying a film of cross-linked fluoropolymer on the surface of the facesheet 110 that is on the side facing away from the core 120.

The cross-linkable fluoropolymer and cross-linked fluoropolymer may be any described as suitable for use in the aerospace panel 100 above. Similarly, the facesheet 110 and core 120 may be any that are known in the art or described herein as suitable for use in the aerospace panel 100 above. If the aerospace panel 100 comprises a second facesheet 140 on the side facing away from the core 120 from the first facesheet 110, the method may further comprise applying a second film of cross-linked fluoropolymer on the surface of the second facesheet 140 that is on the side facing away from the core 120. Alternatively, in such cases the method may further comprise applying a second layer of cross-linkable fluoropolymer on the surface of the second facesheet 140 that is on the side facing away from the core 120; and curing the second layer of cross-linkable fluoropolymer by allowing the fluoropolymer to cross-link. The curing conditions may be any of those disclosed above.

Also provided is an aerospace panel 100 that is the product of any of the above processes.

### D. Examples

### 1. Working Example

### Flammability Test

The flammability of one embodiment of the cross-linked fluoropolymer was compared to TEDLAR, by the protocols of UL94V. Both polymers were tested on a polymer substrate. The TEDLAR layer was about 38 μm thick. A layer of ZEFFLE GK-570 and an isocyanate-type curing agent about 15 μm thick was applied to the substrate. IR-analysis showed the presence of the urethane bonding in the layer. Both samples were tested according to UL94V, and were found to be in Flame Class V-0. Significantly, the ZEFFLE GK-570 matched the performance of the TEDLAR, even though the layer of ZEFFLE GK-570 was less than half as thick as the layer of TEDLAR.

### 2. Working Example

### Toxicity Test

The emissions of toxic gases from one embodiment of the cross-linked fluoropolymer were compared to TEDLAR, by the protocols of BSS 7239, Revision A. The cross-linked fluoropolymer was obtained from ZEFFLE GK-570 and an isocyanate-type curing agent. IR-analysis showed the presence of the urethane bonding. Both polymers met the toxic gas emission limits specified by Boeing Document No. D6-51377, Revision F, Paragraph 4.1b(1) & (3) and Table 1, when tested for toxicity per BSS 7239, Revision A. During the test, ZEFFLE outperformed TEDLAR in emissions of every gas tested, except that neither polymer emitted measurable SO₂ or HF when tested. Whereas TEDLAR emitted 30 ppm of CO, ZEFFLE emitted 20 ppm of CO; whereas TEDLAR emitted 2 ppm of HCl, ZEFFLE emitted 1 ppm of HCl; whereas TEDLAR emitted 8 ppm of NO_{N}, ZEFFLE emitted 4 ppm of NO_{N}; whereas TEDLAR emitted 1 ppm of HCN, ZEFFLE emitted 0.5 ppm of HCN;

### 3. Working Example

### Smoke Test

Smoke production from one embodiment of the cross-linked fluoropolymer were compared to TEDLAR, by the protocols of Boeing Document D6-51377, Revision F, paragraph 4.1b(1) & (3) and Table 2 for general plastic parts, when tested for smoke generation per Boeing Specification Support Standard 7238, “Test Method for Smoke Generation by Materials on Combustion” Revision C, dated 24 May 2006. Films of TEDLAR and ZEFFLE GK-570 were prepared, at about 2 mils thickness (50.8 μm). The film of ZEFFLE GK-570 was obtained from ZEFFLE GK-570 and an isocyanate-type curing agent. IR-analysis showed the presence of the urethane bonding in the film. Both films met the smoke emission limits. Whereas the TEDLAR film had a ⁴Dₘₐₓ of 6, the ZEFFLE had a ⁴Dₘₐₓ of 4. ZEFFLE outperformed TEDLAR in this test.

### E. Conclusions

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. §1.77 or otherwise to provide organizational queues. These headings shall not limit or characterize the invention(s) set forth herein.

Thus, the present invention provides the embodiments as shown below.

1. A method of making a panel for the interior of an aerospace vehicle, the method comprising:
(a) providing a structure comprising an aluminum or fiber composite facesheet and a foam or honeycomb core attached to the facesheet; and
(b) applying a film of cross-linked fluoropolymer on the surface of the facesheet that is on the side facing away from the core.
2. The method of the above 1, in which the cross-linked fluoropolymer comprises a plurality of cross-linkable fluoropolymers that are cross-linked.
3. A method of making a panel for the interior of an aerospace vehicle, the method comprising:
(a) providing a structure comprising an aluminum or fiber composite facesheet and a foam or honeycomb core attached to the facesheet;
(b) applying a layer of cross-linkable fluoropolymer on the surface of the facesheet that is on the side facing away from the core; and
(c) curing the layer of cross-linkable fluoropolymer by allowing the fluoropolymer to cross-link.
4. A panel for the interior of an aerospace vehicle that is the product of any one of the above processes.
5. A panel for the interior of an aerospace vehicle, the panel comprising:
(a) an aluminum or fiber composite facesheet;
(b) a foam or honeycomb core attached to the facesheet; and
(c) a layer of cross-linked fluoropolymer on the surface of the facesheet that is on the side facing away from the core.
6. The panel of the above 5, in which the cross-linked fluoropolymer comprises a plurality of cross-linkable fluoropolymers that are cross-linked.
7. Any one of the above 1-6, in which the foam or honeycomb core comprises a material selected from the group consisting of: a composite of aramid fibers and phenolic resin, and aluminum.
8. Any one of the above 1-7, in which the foam or honeycomb core is a honeycomb core, and comprises a material selected from the group consisting of: a honeycomb of composite of aramid fibers and phenolic resin, and a honeycomb of aluminum.
9. Any one of the above 1-8, in which the facesheet comprises a composite of a fiber and a matrix.
10. Any one of the above 1-9, in which the facesheet comprises a composite of a fiber and a matrix; in which is matrix is a phenolic resin, a thermoplastic resin, or an epoxy; and in which the fiber is a carbon fiber or a glass fiber.
11. A cross-linked fluoropolymer film.
12. The film of the above 11, wherein the film is the product of a process comprising curing the cross-linkable fluoropolymer by allowing the fluoropolymer to cross-link.
13. A method of making a fluoropolymer film, the method comprising:
(a) applying a layer of cross-linkable fluoropolymer to a fluoropolymer substrate;
(b) curing the layer of cross-linkable fluoropolymer by cross-linking the fluoropolymer to create a cured fluoropolymer film; and
(c) removing the cured fluoropolymer film from the substrate.
14. Any one of the above 2-4, 6-10, and 12-13, in which the cross-linkable fluoropolymer is a fluorine-containing copolymer.
15. Any one of the above 2-4, 6-10, and 12-14, in which the cross-linkable fluoropolymer is a fluorine-containing random copolymer.
16. Any one of the above 2-4, 6-10, and 12-15, in which the cross-linkable fluoropolymer is a tetrafluoroethane copolymer.
17. Any one of the above 2-4, 6-10, and 12-16, in which the cross-linkable fluoropolymer is a fluorinated polyol.
18. Any one of the above 2-4, 6-10, and 12-17, in which the cross-linkable fluoropolymer is a copolymer of a plurality of monomers, and in which at least one of the monomers is a flouroalkyl group.
19. Any one of the above 2-4, 6-10, and 12-18, in which the cross-linkable fluoropolymer is a copolymer of a plurality of monomers, and in which at least one of the monomers is:
(a) a flouroalkyl group; or
(b) a substituted alkyl or aryl group comprising a cross-linkable moiety.
20. Any one of the above 2-4, 6-10, and 12-19, in which the cross-linkable fluoropolymer is a copolymer of a plurality of monomers, and in which at least one of the monomers is a fluoroethyl group.
21. Any one of the above 2-4, 6-10, and 12-20, in which the cross-linkable fluoropolymer is a copolymer of a plurality of monomers, and in which at least one of the monomers is a flouroalkyl group selected from the group consisting of: monofluoroethyl, difluoroethyl, trifluoroethyl, and tetrafluoroethyl.
22. Any one of the above 2-4, 6-10, and 12-21, in which the cross-linkable fluoropolymer is a copolymer of a plurality of monomers, and in which at least one of the monomers is a flouroalkyl group having the structure CF₂═CFX, in which X is a halogen.
23. Any one of the above 2-4, 6-10, and 12-22, in which the cross-linkable fluoropolymer is a copolymer of a plurality of monomers, and in which at least one of the monomers is a flouroalkyl group having the structure CF₂═CFX, in which X is F or Cl.
24. Any one of the above 2-4, 6-10, and 12-23, in which the cross-linkable fluoropolymer is a copolymer of a plurality of monomers, and in which at least one of the monomers is a flouroalkyl group having the structure CF₂═CF₂.
25. Any one of the above 2-4, 6-10, and 12-24, in which the cross-linkable fluoropolymer is a copolymer of a plurality of monomers, and in which at least one of the monomers is a substituted ethyl group comprising a cross-linkable.
26. Any one of the above 2-4, 6-10, and 12-25, in which the cross-linkable fluoropolymer is a copolymer of a plurality of monomers, and in which at least one of the monomers is a substituted alkyl group comprising a cross-linkable moiety, in which the substituted alkyl group is

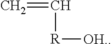

27. Any one of the above 2-4, 6-10, and 12-26, in which the cross-linkable fluoropolymer is a copolymer of a plurality of monomers, in which at least one of the monomers is a substituted alkyl or aryl group comprising a cross-linkable moiety, and in which the cross-linkable moiety is alkoxy or aryloxy.
28. Any one of the above 2-4, 6-10, and 12-27, in which the cross-linkable fluoropolymer is a copolymer of a plurality of monomers, in which at least one of the monomers is a substituted alkyl or aryl group comprising a cross-linkable moiety, and in which the cross-linkable moiety is hydroxyl.
29. Any one of the above 2-4, 6-10, and 12-28, in which the cross-linkable fluoropolymer is a copolymer of a plurality of monomers, in which at least one of the monomers is a substituted alkyl or aryl group comprising a cross-linkable moiety, and in which the cross-linkable moiety is an ether.
30. Any one of the above 2-4, 6-10, and 12-29, in which the cross-linkable fluoropolymer is a copolymer of a plurality of monomers, and in which at least one of the monomers is an alkyl ether.
31. Any one of the above 2-4, 6-10, and 12-30, in which the cross-linkable fluoropolymer is a copolymer of a plurality of monomers, and in which at least one of the monomers is

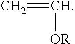

32. Any one of the above 2-4, 6-10, and 12-31, in which the cross-linked fluoropolymer comprises any one of the above cross-linkable fluoropolymers cross-linked to any one of the above cross-linkable fluoropolymers.
33. Any one of the above 1-32, in which the cross-linked fluoropolymer does not produce a measurable amount of hydrogen fluoride gas upon combustion.
34. Any one of the above 2-4, 6-10, and 12-33, in which the cross-linkable fluoropolymer is

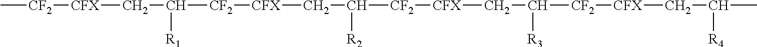

in which X is H or a halogen; and R₃ is a cross-linking moiety.
35. Any one of the above 2-4, 6-10, and 12-34, in which the cross-linkable fluoropolymer is

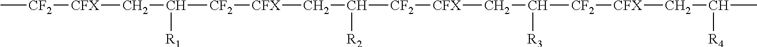

in which X is H or a halogen; R₁ is a group that confers a property selected from the group consisting of: transparency, gloss, and hardness; R₂ is a group that confers flexibility; R₃ is a cross-linking moiety; and R₄ is a group that confers a property selected from the group consisting of pigment compatibility and adhesiveness.
36. Any one of the above 2-4, 6-10, and 12-35, in which the cross-linkable fluoropolymer is a random copolymer comprising the monomers

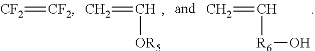

37. Any one of the above 2-4, 6-10, and 12-36, in which the cross-linkable fluoropolymer is a random copolymer comprising the monomers

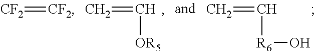

in which R₅ is a group that confers a property selected from gloss, hardener compatibility, and pigment compatibility; and in which —R₆—OH is suitable for cross-linking with polyisocyanates.
38. Any one of the above 1-37, in which the fluoropolymer film or layer is no more than a maximum thickness selected from the group consisting of: 0.25 mil (6.35 μm), 0.5 mil (12.7 μm), 0.75 mil (19.05 μm), 1.0 mil (25.4 μm), 1.25 mil (31.75 μm), 1.5 mil (38.1 μm), 1.75 mil (44.45 μm), 2.0 mil (50.8 μm), 2.25 mil (57.15 μm), 2.5 mil (63.5 μm), and about any of the foregoing thicknesses.
39. Any one of the above 1-38, in which the fluoropolymer film or layer is about 2 mils (50.8 μm) or less in thickness.
40. Any one of the above 1-39, in which the fluoropolymer film or layer is about 0.5-2 mils (12.7-50.8 μm) in thickness.
41. Any one of the above 1-40, in which the fluoropolymer film or layer is about 1 mil (25.4 μm) in thickness.
42. Any one of the above 1-41, in which the fluoropolymer film or layer is about 0.59 mils (15 μm) thick.
43. Any one of the above 1-42, in which the cross-linked fluoropolymer meets the smoke emissions requirements specified in Boeing Document D6-51377, Revision F, paragraph 4.1b(1) & (3) and Table 2 for general plastic parts, when tested for smoke generation per Boeing Specification Support Standard 7238, “Test Method for Smoke Generation by Materials on Combustion” Revision C, dated 24 May 2006.
44. Any one of the above 1-43, in which the density of smoke (⁴Dₘₐₓ) produced by the cross-linked fluoropolymer does not exceed about 200 when tested for smoke generation per Boeing Specification Support Standard 7238, “Test Method for Smoke Generation by Materials on Combustion” Revision C, dated 24 May 2006.
45. Any one of the above 1-44 in which the ⁴Dₘₐₓ of the smoke produced by the cross-linked fluoropolymer is less than about 6 when tested for smoke generation per Boeing Specification Support Standard 7238, “Test Method for Smoke Generation by Materials on Combustion” Revision C, dated 24 May 2006.
46. Any one of the above 1-45 in which the ⁴Dₘₐₓ of the smoke produced by the cross-linked fluoropolymer does not exceed about 4 when tested for smoke generation per Boeing Specification Support Standard 7238, “Test Method for Smoke Generation by Materials on Combustion” Revision C, dated 24 May 2006.
47. Any one of the above 1-46 in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: the concentration of HCl generated does not exceed about 500 ppm, the concentration of NOₓ generated does not exceed about 100 ppm, the concentration of HCN generated does not exceed about 150 ppm, the concentration of SO₂ generated does not exceed about 100 ppm, and the concentration of HF generated does not exceed about 200 ppm.
48. Any one of the above 1-47 in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: CO below about 30 ppm, HCl below about 2 ppm, NOₓ below about 8 ppm, HCN below about 1 ppm, SO₂ at about 0 ppm, and HF at about 0 ppm.
49. Any one of the above 1-48 in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: CO does not exceed about 20 ppm, HCl does not exceed about 1 ppm, NOₓ does not exceed about 4 ppm, HCN does not exceed about 0.5 ppm, SO₂ at about 0 ppm, and HF at about 0 ppm.
50. Any one of the above 1-49 in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at all of the following levels: CO does not exceed about 20 ppm, HCl does not exceed about 1 ppm, NOₓ does not exceed about 4 ppm, HCN does not exceed about 0.5 ppm, SO₂ at about 0 ppm, and HF at about 0 ppm.
51. Any one of the above 1-50 in which the cross-linked fluoropolymer emits no detectable HF in the absence of an agent that absorbs HF when tested for toxicity in the flaming test mode per Boeing Specification Support Standard 7239, “Test Method for Toxic Gas Generation by Materials Combustion,” Revision A, dated 18 Jan. 1988.
52. Any one of the above 1-51 excluding an agent that absorbs HF at sufficient levels to absorb HF that would otherwise be emitted by the burning cross-linked fluoropolymer.
53. Any one of the above 1-52 in which the cross-linked fluoropolymer is flame resistant, and will be rated as V-0 or better when tested according to UL 94, “Standard for Safety of Flammability of Plastic Materials for Parts in Devices and Appliances Testing.”
54. A method of making a panel for the interior of an aerospace vehicle, the method comprising:
(a) providing a structure comprising an aluminum or fiber composite facesheet and a foam or honeycomb core attached to the facesheet; and
(b) applying a film of cross-linked fluoropolymer on the surface of the facesheet that is on the side facing away from the core.
55. The method of the above 54, in which the cross-linked fluoropolymer comprises a plurality of cross-linkable fluoropolymers that are cross-linked.
56. A method of making a panel for the interior of an aerospace vehicle, the method comprising:
(a) providing a structure comprising an aluminum or fiber composite facesheet and a foam or honeycomb core attached to the facesheet;
(b) applying a layer of cross-linkable fluoropolymer on the surface of the facesheet that is on the side facing away from the core; and
(c) curing the layer of cross-linkable fluoropolymer by allowing the fluoropolymer to cross-link.
57. A panel for the interior of an aerospace vehicle that is the product of any one of the processes of the above 54-56.
58. A panel for the interior of an aerospace vehicle, the panel comprising:
(a) an aluminum or fiber composite facesheet;
(b) a foam or honeycomb core attached to the facesheet; and
(c) a layer of cross-linked fluoropolymer on the surface of the facesheet that is on the side facing away from the core.
59. The panel of the above 58, in which the cross-linked fluoropolymer comprises a plurality of cross-linkable fluoropolymers that are cross-linked.
60. Any one of the above 54-56 and 58-59, in which the foam or honeycomb core comprises a material selected from the group consisting of: a composite of aramid fibers and phenolic resin, and aluminum.
61. Any one of the above 54-56 and 58-59, in which the foam or honeycomb core is a honeycomb core, and comprises a material selected from the group consisting of: a honeycomb of composite of aramid fibers and phenolic resin, and a honeycomb of aluminum.
62. Any one of the above 54-56 and 58-59, in which the facesheet comprises a composite of a fiber and a matrix.
63. Any one of the above 54-56 and 58-59, in which the facesheet comprises a composite of a fiber and a matrix; in which the matrix is a phenolic resin, a thermoplastic resin, or an epoxy; and in which the fiber is a carbon fiber or a glass fiber.
64. A cross-linked fluoropolymer film.
65. The film of the above 64, wherein the film is the product of a process comprising curing the cross-linkable fluoropolymer by allowing the fluoropolymer to cross-link.
66. A method of making a fluoropolymer film, the method comprising:
(a) applying a layer of cross-linkable fluoropolymer to a fluoropolymer substrate;
(b) curing the layer of cross-linkable fluoropolymer by cross-linking the fluoropolymer to create a cured fluoropolymer film; and
(c) removing the cured fluoropolymer film from the substrate.
67. Any one of the above 55, 56, 59, 65, and 66, in which the cross-linkable fluoropolymer is a fluorine-containing copolymer.
68. Any one of the above 55, 56, 59, 65, and 66, in which the cross-linkable fluoropolymer is a fluorine-containing random copolymer.
69. Any one of the above 55, 56, 59, 65, and 66, in which the cross-linkable fluoropolymer is a tetrafluoroethane copolymer.
70. Any one of the above 55, 56, 59, 65, and 66, in which the cross-linkable fluoropolymer is a fluorinated polyol.
71. Any one of the above 55, 56, 59, 65, and 66, in which the cross-linkable fluoropolymer is a copolymer of a plurality of monomers, and in which at least one of the monomers is a fluoroalkyl group.
72. Any one of the above 55, 56, 59, 65, and 66, in which the cross-linkable fluoropolymer is a copolymer of a plurality of monomers, and in which at least one of the monomers is:
(a) a fluoroalkyl group; or
(b) a substituted alkyl or aryl group comprising a cross-linkable moiety.
73. Any one of the above 55, 56, 59, 65, and 66, in which the cross-linkable fluoropolymer is a copolymer of a plurality of monomers, in which at least one of the monomers is a fluoroalkyl group, and in which the fluoroalkyl group is fluoroethyl.
74. Any one of the above 55, 56, 59, 65, and 66, in which the cross-linkable fluoropolymer is a copolymer of a plurality of monomers, in which at least one of the monomers is a fluoroalkyl group, and in which the fluoroalkyl group is monofluoroethyl, difluoroethyl, trifluoroethyl, or tetrafluoroethyl.
75. Any one of the above 55, 56, 59, 65, and 66, in which the cross-linkable fluoropolymer is a copolymer of a plurality of monomers, in which at least one of the monomers is a fluoroalkyl group, and in which the fluoroalkyl group is CF₂═CFX, in which X is a halogen.
76. Any one of the above 55, 56, 59, 65, and 66, in which the cross-linkable fluoropolymer is a copolymer of a plurality of monomers, in which at least one of the monomers is a fluoroalkyl group, and in which the fluoroalkyl group is CF₂═CFX, in which X is Cl or F.
77. Any one of the above 55, 56, 59, 65, and 66, in which the cross-linkable fluoropolymer is a copolymer of a plurality of monomers, in which at least one of the monomers is a fluoroalkyl group, and in which the fluoroalkyl group is CF₂═CF₂.
78. Any one of the above 55, 56, 59, 65, and 66, in which the cross-linkable fluoropolymer is a copolymer of a plurality of monomers, in which at least one of the monomers is a substituted alkyl or aryl group comprising a cross-linkable moiety, and in which the substituted alkyl group is a substituted ethyl group.
79. Any one of the above 55, 56, 59, 65, and 66, in which the cross-linkable fluoropolymer is a copolymer of a plurality of monomers, in which at least one of the monomers is a substituted alkyl or aryl group comprising a cross-linkable moiety, and in which the substituted alkyl group is CH₂═CH—R—OH.
80. Any one of the above 55, 56, 59, 65, and 66, in which the cross-linkable fluoropolymer is a copolymer of a plurality of monomers, in which at least one of the monomers is a substituted alkyl or aryl group comprising a cross-linkable moiety, and in which the cross-linkable moiety is alkoxy or aryloxy.
81. Any one of the above 55, 56, 59, 65, and 66, in which the cross-linkable fluoropolymer is a copolymer of a plurality of monomers, in which at least one of the monomers is a substituted alkyl or aryl group comprising a cross-linkable moiety, and in which the cross-linkable moiety is hydroxyl.
82. Any one of the above 55, 56, 59, 65, and 66, in which the cross-linkable fluoropolymer is a copolymer of a plurality of monomers, in which at least one of the monomers is a substituted alkyl or aryl group comprising a cross-linkable moiety, and in which the cross-linkable moiety is an ether.
83. Any one of the above 55, 56, 59, 65, and 66, in which the cross-linkable fluoropolymer is a copolymer of a plurality of monomers, and in which at least one of the monomers is an alkyl ether.
84. Any one of the above 55, 56, 59, 65, and 66, in which the cross-linkable fluoropolymer is a copolymer of a plurality of monomers, and in which at least one of the monomers is CH₂═CH—OR.
85. Any one of the above 55, 56, 59, 65, and 66, in which the cross-linked fluoropolymer does not produce a measurable amount of hydrogen fluoride gas upon combustion.
86. Any one of the above 55, 56, 59, 65, and 66, in which the cross-linkable fluoropolymer is

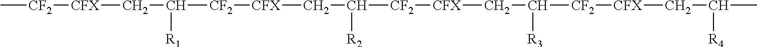

in which X is H or a halogen; and R₃ is a cross-linking moiety.
87. Any one of the above 55, 56, 59, 65, and 66, in which the cross-linkable fluoropolymer is

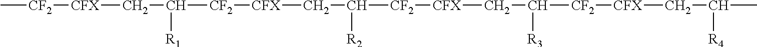

in which X is H or a halogen; R₁ is a group that confers a property selected from the group consisting of: transparency, gloss, and hardness; R₂ is a group that confers flexibility; R₃ is a cross-linking moiety; and R₄ is a group that confers a property selected from the group consisting of pigment compatibility and adhesiveness.
88. Any one of the above 55, 56, 59, 65, and 66, in which the cross-linkable fluoropolymer is a random copolymer comprising the monomers

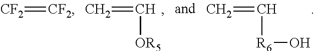

89. Any one of the above 55, 56, 59, 65, and 66, in which the cross-linkable fluoropolymer is a random copolymer comprising the monomers

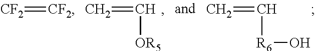

in which R₅ is a group that confers a property selected from gloss, hardener compatibility, and pigment compatibility; and in which —R₆—OH is suitable for cross-linking with polyisocyanates.
90. Any one of the above 54-56, 58, 59, and 64-66, in which the fluoropolymer film or layer is no more than a maximum thickness selected from the group consisting of: 0.25 mil (6.35 μm), 0.5 mil (12.7 μm), 0.75 mil (19.05 μm), 1.0 mil (25.4 μm), 1.25 mil (31.75 μm), 1.5 mil (38.1 μm), 1.75 mil (44.45 μm), 2.0 mil (50.8 μm), 2.25 mil (57.15 μm), 2.5 mil (63.5 μm), and about any of the foregoing thicknesses.
91. Any one of the above 54-56, 58, 59, and 64-66, in which the fluoropolymer film or layer is about 0.5-2 mils (12.7-50.8 μm) in thickness.
92. Any one of the above 54-56, 58, 59, and 64-66, in which the fluoropolymer film or layer is about 1 mil (25.4 μm) thick.
93. Any one of the above 54-56, 58, 59, and 64-66, in which the fluoropolymer film or layer is about 0.59 mils (15 μm) thick.
94. Any one of the above 54-56, 58, 59, and 64-66, in which the cross-linked fluoropolymer meets the smoke emissions requirements specified in Boeing Document D6-51377, Revision F, paragraph 4.1b(1) & (3) and Table 2 for general plastic parts, when tested for smoke generation per Boeing Specification Support Standard 7238, “Test Method for Smoke Generation by Materials on Combustion” Revision C, dated 24 May 2006.
95. Any one of the above 54-56, 58, 59, and 64-66, in which the density of smoke (⁴Dₘₐₓ) produced by the cross-linked fluoropolymer does not exceed about 200 when tested for smoke generation per Boeing Specification Support Standard 7238, “Test Method for Smoke Generation by Materials on Combustion” Revision C, dated 24 May 2006.
96. Any one of the above 54-56, 58, 59, and 64-66, in which the ⁴Dₘₐₓ of the smoke produced by the cross-linked fluoropolymer is less than about 6 when tested for smoke generation per Boeing Specification Support Standard 7238, “Test Method for Smoke Generation by Materials on Combustion” Revision C, dated 24 May 2006.
97. Any one of the above 54-56, 58, 59, and 64-66, in which the ⁴Dₘₐₓ of the smoke produced by the cross-linked fluoropolymer does not exceed about 4 when tested for smoke generation per Boeing Specification Support Standard 7238, “Test Method for Smoke Generation by Materials on Combustion” Revision C, dated 24 May 2006.
98. Any one of the above 54-56, 58, 59, and 64-66, in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: the concentration of HCl generated does not exceed about 500 ppm, the concentration of NOₓ generated does not exceed about 100 ppm, the concentration of HCN generated does not exceed about 150 ppm, the concentration of SO₂ generated does not exceed about 100 ppm, and the concentration of HF generated does not exceed about 200 ppm.
99. Any one of the above 54-56, 58, 59, and 64-66, in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: CO below about 30 ppm, HCl below about 2 ppm, NOₓ below about 8 ppm, HCN below about 1 ppm, SO₂ at about 0 ppm, and HF at about 0 ppm.
100. Any one of the above 54-56, 58, 59, and 64-66, in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at a level selected from the group consisting of: CO does not exceed about 20 ppm, HCl does not exceed about 1 ppm, NOₓ does not exceed about 4 ppm, HCN does not exceed about 0.5 ppm, SO₂ at about 0 ppm, and HF at about 0 ppm.
101. Any one of the above 54-56, 58, 59, and 64-66, in which the cross-linked fluoropolymer generates a toxic gas when tested for toxicity in the flaming test mode per Boeing Specification Support Standard 7239, “Test Method for Toxic Gas Generation by Materials Combustion,” Revision A, dated 18 Jan. 1988 at all of the following levels: CO does not exceed about 20 ppm, HCl does not exceed about 1 ppm, NOₓ does not exceed about 4 ppm, HCN does not exceed about 0.5 ppm, SO₂ at about 0 ppm, and HF at about 0 ppm.
102. Any one of the above 54-56, 58, 59, and 64-66, in which the cross-linked fluoropolymer emits no detectable HF in the absence of an agent that absorb HF when tested for toxicity in the flaming test mode per Boeing Specification Support Standard 7239, “Test Method for Toxic Gas Generation by Materials Combustion,” Revision A, dated 18 Jan. 1988.
103. Any one of the above 54-56, 58, 59, and 64-66, excluding an agent that absorbs HF at sufficient levels to absorb HF that would otherwise be emitted by the burning cross-linked fluoropolymer.
104. Any one of the above 54-56, 58, 59, and 64-66, in which the cross-linked fluoropolymer is flame resistant, and will be rated as V-0 or better when tested according to UL 94, “Standard for Safety of Flammability of Plastic Materials for Parts in Devices and Appliances Testing.”

Another aspect of the invention is a cross-linked fluoropolymer film which is characterized in that the film includes urethane bonding. The cross-linked fluoropolymer film has high flame resistance and hardly produces toxic gas and smoke gas. The presence of the urethane bonding in the film can be confirmed by IR-analysis.

The cross-linked fluoropolymer film is preferably obtained from a cross-linkable fluoropolymer and a curing agent from the view point of flame resistance, low toxic gas emission, and low smoke gas emission.

The cross-linkable fluoropolymer is preferably a copolymer of a plurality of monomers, in which at least one of the monomers comprises a cross-linkable moiety. That is, the cross-linkable fluoropolymer is preferably a curable functional group-containing fluorinated polymer.

The above-mentioned curable functional group-containing fluorinated polymer can be exemplified by a polymer provided by the introduction of a curable functional group into a fluorinated polymer. This fluorinated polymer encompasses resinous polymers that have a distinct melting point, elastomeric polymers that exhibit rubbery elasticity, and thermoplastic elastomeric polymers intermediate between these two.

The functional group that imparts curability to the fluorinated polymer can be exemplified by the hydroxyl group (but excluding the hydroxyl group present in the carboxyl group; this also applies hereafter), the carboxyl group, the group represented by —COOCO—, the cyano group, the amino group, the glycidyl group, the silyl group, the silanate group, and the isocyanate group, and is selected as appropriate in conformity with the ease of production of the polymer and the curing system. Among the preceding, at least one group selected from the group consisting of the hydroxyl group, the carboxyl group, the group represented by —COOCO—, the cyano group, the amino group, and the silyl group is preferred for the excellent curing reactivity thereby provided, while at least one group selected from the group consisting of the hydroxyl group, the carboxyl group, the amino group, and the silyl group is more preferred. At least one group selected from the group consisting of the hydroxyl group and the carboxyl group is even more preferred in particular for the excellent reactivity and ease of polymer acquisition thereby provided.

The hydroxyl group is most preferred from the view point of flame resistance, low toxic gas emission, and low smoke gas emission. That is, the cross-linkable moiety is preferably hydroxyl.

The urethane bonding may be formed by reacting hydroxyl of the cross-linkable fluoropolymer and the isocyanate.

The above-mentioned curable functional groups are generally introduced into the fluorinated polymer by copolymerization between a fluorine-containing monomer and a curable functional group-containing monomer.

The curable functional group-containing monomer can be exemplified by hydroxyl group-containing monomers, carboxyl group-containing monomers, acid anhydride monomers, amino group-containing monomers, and silicone-based vinyl monomers, and a single one of these may be used or two or more may be used.

The curable functional group-containing fluorinated polymer under consideration preferably contains a polymerization unit based on a fluorine-containing monomer and a polymerization unit based on at least one curable functional group-containing monomer selected from the group consisting of hydroxyl group-containing monomers, carboxyl group-containing monomers, acid anhydride monomers, amino group-containing monomers, and silicone-based vinyl monomers. This curable functional group-containing fluorinated polymer more preferably contains a polymerization unit based on a fluorine-containing monomer and a polymerization unit based on at least one curable functional group-containing monomer selected from the group consisting of hydroxyl group-containing monomers and carboxyl group-containing monomers.

The polymerization unit based on curable functional group-containing monomer is preferably 1 to 20 mol % with respect to the total polymerization units in the curable functional group-containing fluorinated polymer. A more preferred lower limit is 2 mol % and a more preferred upper limit is 10 mol %.

The curable functional group-containing monomer can be exemplified by the following, but is not limited only to these examples. A single one of these may be used or two or more may be used.

### (1-1) The Hydroxyl Group-Containing Monomer:

The hydroxyl group-containing monomer can be exemplified by hydroxyl group-containing vinyl ethers, e.g., 2-hydroxyethyl vinyl ether, 3-hydroxypropyl vinyl ether, 2-hydroxypropyl vinyl ether, 2-hydroxy-2-methylpropyl vinyl ether, 4-hydroxybutyl vinyl ether, 4-hydroxy-2-methylbutyl vinyl ether, 5-hydroxypentyl vinyl ether, and 6-hydroxyhexyl vinyl ether, and by hydroxyl group-containing allyl ethers such as 2-hydroxyethyl allyl ether, 4-hydroxybutyl allyl ether, and glycerol monoallyl ether. The hydroxyl group-containing vinyl ethers, and particularly 4-hydroxybutyl vinyl ether and 2-hydroxyethyl vinyl ether, are preferred among the preceding for their excellent polymerization reactivity and excellent functional group curability.

The hydroxyalkyl esters of (meth)acrylic acid, e.g., 2-hydroxyethyl acrylate and 2-hydroxyethyl methacrylate, are examples of other hydroxyl group-containing monomers.

The carboxyl group-containing monomers given below are not encompassed by the hydroxyl group-containing monomers cited above.

### (1-2) The Carboxyl Group-Containing Monomer:

The carboxyl group-containing monomer can be exemplified by unsaturated carboxylic acids represented by general formula (1)

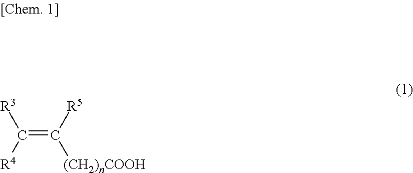

(in the formula, R³, R⁴, and R⁵ are each independently the hydrogen atom, an alkyl group, an aryl group, the carboxyl group, or an alkoxycarbonyl group, and n is 0 or 1), e.g., unsaturated monocarboxylic acids, unsaturated dicarboxylic acids and their monoesters, and so forth, and can also be exemplified by carboxyl group-containing vinyl ether monomers represented by general formula (2)

[Chem. 2]

CH₂═CHCH₂ₙOR⁶OCOₘR⁷COOH (2)

(in the formula, R⁶ and R⁷ are each independently a saturated or unsaturated, straight-chain or cyclic alkyl group, n is 0 or 1, and m is 0 or 1).

The unsaturated carboxylic acids represented by general formula (1) can be specifically exemplified by acrylic acid, methacrylic acid, vinylacetic acid, crotonic acid, cinnamic acid, itaconic acid, monoesters of itaconic acid, maleic acid, maleate monoesters, fumaric acid, and fumarate monoesters. Among the preceding, low-homopolymerizable crotonic acid, itaconic acid, maleic acid, maleate monoesters, fumaric acid, and fumarate monoesters are preferred because they have a low homopolymerizable and thus are resistant to the formation of homopolymers.

The carboxyl group-containing vinyl ether monomer represented by general formula (2) can be specifically exemplified by one or two or more selections from 3-allyloxypropionic acid, 3-(2-allyloxyethoxycarbonyl)propionic acid, 3-(2-allyloxybutoxycarbonyl)propionic acid, 3-(2-vinyloxyethoxycarbonyl)propionic acid, 3-(2-vinyloxybutoxycarbonyl)propionic acid, and so forth. Among the preceding, 3-(2-allyloxyethoxycarbonyl)propionic acid and so forth offer the advantages of good monomer stability and good polymerization reactivity and thus are preferred.

In addition to the carboxyl group-containing monomers represented by general formulas (1) and (2), the alkenyl esters of polybasic carboxylic acids, e.g., vinyl phthalate and vinyl pyromellitate, can be used as the carboxyl group-containing monomer.

### (1-3) The Acid Anhydride Monomer:

The acid anhydride monomer can be exemplified by the anhydrides of unsaturated dicarboxylic acids, e.g., maleic anhydride and so forth.

### (1-4) The Amino Group-Containing Monomer:

The amino group-containing monomer can be exemplified by amino vinyl ethers represented by CH₂═CH—O—(CH₂)ₓ—NH₂ (x=0 to 10), amines represented by CH₂═CH—O—CO(CH₂)ₓ—NH₂ (x=1 to 10), and also aminomethylstyrene, vinylamine, acrylamide, vinylacetamide, and vinylformamide.

### (1-5) The Silicone-Based Vinyl Monomer:

The silicone-based vinyl monomer can be exemplified by (meth)acrylate esters such as CH₂═CHCO₂(CH₂)₃Si(OCH₃)₃, CH₂═CHCO₂(CH₂)₃Si(OC₂H₅)₃, CH₂═C(CH₃)CO₂(CH₂)₃Si(OCH₃)₃, CH₂═C(CH₃)CO₂(CH₂)₃Si(OC₂H₅)₃, CH₂═CHCO₂(CH₂)₃SiCH₃(OC₂H₅)₂, CH₂—C(CH₃)CO₂(CH₂)₃SiC₂H₅(OCH₃)₂, CH₂—C(CH₃)CO₂(CH₂)₃Si(CH₃)₂(OC₂H₅), CH₂—C(CH₃)CO₂(CH₂)₃Si(CH₃)₂OH, CH₂═CH(CH₂)₃Si(OCOCH₃)₃, CH₂═C(CH₃)CO₂(CH₂)₃SiC₂H₅(OCOCH₃)₂, CH₂═C(CH₃)CO₂(CH₂)₃SiCH₃(N(CH₃)COCH₃)₂, CH₂═CHCO₂(CH₂)₃SiCH₃[ON(CH₃)C₂H₅]₂, and CH₂—C(CH₃)CO₂(CH₂)₃SiC₆H₅[ON(CH₃)C₂H₅]₂; vinylsilanes such as CH₂═CHSi[ON═C(CH₃)(C₂H₅)]₃, CH₂═CHSi(OCH₃)₃, CH₂═CHSi(OC₂H₅)₃, CH₂═CHSiCH₃(OCH₃)₂, CH₂═CHSi(OCOCH₃)₃, CH₂═CHSi(CH₃)₂(OC₂H₅), CH₂═CHSi(CH₃)₂SiCH₃(OCH₃)₂, CH₂═CHSiC₂H₅(OCOCH₃)₂, and CH₂═CHSiCH₃[ON(CH₃)C₂H₅]₂, vinyltrichlorosilane, and the partial hydrolyzates of the preceding; and vinyl ethers such as trimethoxysilylethyl vinyl ether, triethoxysilylethyl vinyl ether, trimethoxysilylbutyl vinyl ether, methyldimethoxysilylethyl vinyl ether, trimethoxysilylpropyl vinyl ether, and triethoxysilylpropyl vinyl ether.

The fluorine-containing monomer, i.e., the monomer for forming a fluorinated polymer into which a curable functional group has been introduced, can be exemplified by tetrafluoroethylene, chlorotrifluoroethylene, vinylidene fluoride, vinyl fluoride, and fluorovinyl ether, and a single one of these may be used or two or more may be used.

Preferred among the preceding is at least one selection from the group consisting of tetrafluoroethylene, chlorotrifluoroethylene, and vinylidene fluoride, while at least one selection from the group consisting of tetrafluoroethylene and chlorotrifluoroethylene is even more preferred from the view point of flame resistance, low toxic gas emission, and low smoke gas emission. Therefore, the cross-linkable fluoropolymer is preferably a copolymer of a plurality of monomers, in which at least one of the monomers is CF₂═CFX, in which X is a halogen. X is preferably F or Cl, more preferably F.

The fluorinated polymer into which a curable functional group has been introduced can be exemplified by the following, categorized according to the polymerization units constituting the polymer.

(1) Perfluoroolefin-Based Polymers that Mainly Contain a Perfluoroolefin Unit:

These can be specifically exemplified by tetrafluoroethylene (TFE) homopolymers, copolymers between TFE and, e.g., hexafluoropropylene (HFP) or perfluoro(alkyl vinyl ether) (PAVE), and copolymers of the preceding with another copolymerizable monomer.

This other copolymerizable monomer can be exemplified by vinyl carboxylate esters such as vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl para-t-butylbenzoate; alkyl vinyl ethers such as methyl vinyl ether, ethyl vinyl ether, butyl vinyl ether, and cyclohexyl vinyl ether; fluorine-free olefins such as ethylene, propylene, n-butene, and isobutene; and fluorine-containing monomers such as vinylidene fluoride (VdF), chlorotrifluoroethylene (CTFE), vinyl fluoride (VF), and fluorovinyl ether, but there is no limitation to only these.

Among the preceding, TFE-based polymers that mainly contain TFE are preferred for their excellent pigment dispersibility, excellent weathering resistance, excellent copolymerizability, and excellent chemical resistance.

Curable functional group-containing perfluoroolefin-based polymers can be specifically exemplified by copolymers of TFE/isobutylene/hydroxybutyl vinyl ether/other monomer, copolymers of TFE/vinyl versatate/hydroxybutyl vinyl ether/other monomer, and copolymers of TFE/VdF/hydroxybutyl vinyl ether/other monomer, while copolymers of TFE/isobutylene/hydroxybutyl vinyl ether/other monomer and copolymers of TFE/vinyl versatate/hydroxybutyl vinyl ether/other monomer are preferred.

An example of a TFE-based curable polymer composition for application as a coating material is the Zeffle GK series from Daikin Industries, Ltd.

(2) CTFE-Based Polymers that Mainly Contain the Chlorotrifluoroethylene (CTFE) Unit:

Specific examples here are copolymers of CTFE/hydroxybutyl vinyl ether/other monomer.

Examples of CTFE-based curable polymer compositions for application as a coating material are Lumiflon from Asahi Glass Co., Ltd., Fluonate from the DIC Corporation, Cefral Coat from Central Glass Co., Ltd., and Zaflon from Toagosei Co., Ltd.

(3) VdF-Based Polymers that Mainly Contain the Vinylidene Fluoride (VdF) Unit:

Specific examples here are VdF/TFE/hydroxybutyl vinyl ether/other monomer copolymers.

(4) Fluoroalkyl Group-Containing Polymers that Mainly Contain a Fluoroalkyl Unit:

Specific examples here are CF₃CF₂(CF₂CF₂)ₙCH₂CH₂OCOCH═CH₂ (n=mixture of 3 and 4)/2-hydroxyethyl methacrylate/stearyl acrylate copolymers.

The fluoroalkyl group-containing polymer can be exemplified by Unidyne and Ftone, both from Daikin Industries, Ltd., and Zonyl from Du Pont Co., Ltd.

Among the preceding, the perfluoroolefin-based polymers are preferred when one considers the weathering resistance and moistureproofness.

The curable functional group-containing fluorinated polymer can be prepared, for example, by the method disclosed in JP-A 2004-204205.

The content of the curable functional group-containing fluorinated polymer in the coating material for the present invention is preferably 20 to 100 mass % where the total amount of nonvolatile components in the coating material is 100 mass %.

The above-mentioned curable functional groups are generally introduced into the fluorinated polymer by copolymerization between a fluorine-containing monomer and a curable functional group-containing monomer.

The curing agent to be used may be formed into a compound capable of reacting and crosslinking with a curable functional group of the fluorinated polymer. Commonly used are, for example, isocyanates, amino resins, acid anhydrides, polyepoxy compounds, and isocyanate group-containing silane compounds. Among them, isocyanates are preferred since the urethane bonding is easily formed and, therefore, high flame resistance, low toxic gas emission, and low smoke gas emission are achieved.

Specific examples of the isocyanates include, but are not limited to, 2,4-tolylene diisocyanate, diphenylmethane-4,4′-diisocyanate, xylylene diisocyanate, isophorone diisocyanate, lysine methyl ester diisocyanate, methylcyclohexyl diisocyanate, trimethyl hexamethylene diisocyanate, hexamethylene diisocyanate, n-pentane-1,4-diisocyanate, trimers thereof, adduct forms thereof, biuret forms thereof, polymers thereof having two or more isocyanate groups, and further blocked isocyanates.

The cross-linked fluoropolymer film is suitable for an interior of an aerospace vehicle such as an aircraft. For example, the layer of cross-linked fluoropolymer 130 may be a cross-linked fluoropolymer film.

Another aspect of the invention is a panel for an interior of an aerospace vehicle, the panel comprising:

an aluminum or fiber composite facesheet,
a foam or honeycomb core attached the facesheet, and
the above cross-linked fluoropolymer film on the surface of the facesheet that is on the side facing away from the core.

The present application claims benefit under 35 U.S.C. §119(e) of U.S. Non-provisional application Ser. No. 14/191,028 filed on Feb. 26, 2014, incorporated herein by reference in its entirety.

1. A cross-linked fluoropolymer film, which includes urethane bonding.

2. The cross-linked fluoropolymer film of claim 1, which is obtained from a cross-linkable fluoropolymer and an isocyanate.

3. The cross-linked fluoropolymer film of claim 2, in which the cross-linkable fluoropolymer is a copolymer of a plurality of monomers, in which at least one of the monomers comprises a cross-linkable moiety, and in which the cross-linkable moiety is hydroxyl.

4. The cross-linked fluoropolymer film of claim 3, in which the urethane bonding is formed by reacting hydroxyl of the cross-linkable fluoropolymer and the isocyanate.

5. The cross-linked fluoropolymer film of claim 2, in which the cross-linkable fluoropolymer is a copolymer of a plurality of monomers, in which at least one of the monomers is CF₂═CFX, in which X is a halogen.

6. The cross-linked fluoropolymer film of claim 1, which is used for an interior of an aerospace vehicle.

7. The cross-linked fluoropolymer film of claim 6, in which the aerospace vehicle is an aircraft.

8. A panel for an interior of an aerospace vehicle, the panel comprising:
an aluminum or fiber composite facesheet,
a foam or honeycomb core attached the facesheet, and
the cross-linked fluoropolymer film of claim 1 on the surface of the facesheet that is on the side facing away from the core.
